(19) United States
(12) Patent Application Publication
(10) Pub. No.: US 2003/0154881 A1
(43) Pub. Date: Aug. 21, 2003

(54) Gels exhibiting reversible opacity change

(75) Inventor: Jeffrey L. Conroy, Rumford, RI (US)

Correspondence Address: HARRINGTON & SMITH, LLP, 4 RESEARCH DRIVE, SHELTON, CT, 06484-6212, US

(73) Assignee: Spectra Systems Corporation, Providence, RI

(21) Appl. No.: 10/124,964

(22) Filed: Apr. 17, 2002

Related U.S. Application Data
(60) Provisional application No. 60/358,482, filed on Feb. 19, 2002.

(51) Int. Cl. C09D 11/00

(52) U.S. Cl. 106/31.13; 428/342; 503/201

(57) ABSTRACT

Described are aqueous solutions of materials that can be formed into mechanically robust gels that exhibit reversible LCST behavior. The use of a curable crosslinking agent beneficially allows the LCST materials to be processed as solutions. Since the LCST material is a solution, the incorporation of additional components, including surfactants, which modify the LCST transition point is also facilitated. Finally, the blending of other formulation components, such as, but not limited to, optical brighteners, dyes, surfactants, and other components is greatly facilitated by the low viscosity nature of the solution.

### TECHNICAL FIELD

These teachings relate generally to polymers that exhibit a reversible opacity change due to a lower critical solution temperature (LCST) phenomenon and, more specifically, relate to aqueous-based gels that exhibit LCST behavior.

### BACKGROUND

As commercial enterprise has continued to devise more complicated schemes, a genuine need has developed for a material that can reversibly change opacity, and yet be as versatile as a film. For example, such a material would be of great benefit in the identification and sorting of articles. Specifically, consider the following.

Methods for sorting articles have become increasingly reliant upon the use of bar codes and other similar data forms for making rapid identification of items. Many of these marking systems rely upon coding that can be “read” by an electronic system. Such systems typically require illumination of the marking, optical imaging and signal processing to ascertain information carried by the marking. Advantages of such systems include offering users an ability to automate identification steps of various processes. However, certain situations can render the use of existing technology ineffective. As an example, a summary of mail sorting techniques provides an example of the challenges faced by individuals reliant upon existing technology for identification and sorting of items.

The United States Postal Service (USPS) currently sorts mail using a bar code system. In order to sort the mail, the USPS optically reads address information with an optical character recognition (OCR) imaging system. A bar code is then applied by the USPS to the mail piece, which provides for subsequent identification and sorting prior to delivery. This type of mail sorting technique is described in European Patent EP 509280-A2, entitled “Bar code translation for deferred optical character recognition mail processing—allowing use of local formats of bar code reading and sorting of mail pieces during incoming sort.” For most mail pieces, reading the bar code is not a problem, as white or light colored backgrounds provide adequate contrast, thus allowing bar code imaging equipment to operate effectively.

However, it has been discovered that problems arise when colored, multi-colored or complex backgrounds lie beneath the bar code. In such instances, the nature of the substrate background typically dampens the signal to noise ratio (SNR) in the bar code imaging equipment, or otherwise causes problems, thus providing incorrect or incomplete information to system operators and/or to automated equipment that relies on a correctly read bar code. The reduced reliability in the imaging of coded information lying on top of the substrate background typically results from poor contrast between the coded information and the substrate background.

For example, business mail and periodicals often contain multi-colored graphical patterns associated with decorative elements and advertising on outer surfaces of the mail piece, and the mail piece itself may be enclosed within a transparent plastic wrapping. If a bar code or some other computer readable indicia is to be applied to and then read from the mail piece, or the plastic wrapping, then it can be realized that the underlying graphical pattern can significantly interfere with the ability of a bar code scanner mechanism to correctly read the bar code.

While at first glance it might appear that one could simply apply a neutral label to the mail piece, and then place the bar code on the label, this approach would be objectionable for a number of reasons. First, it adds cost and complexity to the mail piece marking and coding process. Second, the label might be applied over an important element of the underlying graphical pattern, such as over a telephone number or over an Internet address of a company that has placed an advertisement on the outer surface of the mail piece. Third, the presence of the label may be visually and aesthetically objectionable when located upon a carefully designed artwork pattern that forms a portion of an advertisement or some other type of message or decoration on the mail piece.

Thus, a method of solving these problems that involves the application of a contrasting label that carries bar code information is problematic, as application of a separate label may obscure important information on the mail piece and/or it may cause other problems. At present, versatile films that can be used to address this problem have yet to be developed.

A number of polymer blends and polymer solutions have been reported that exhibit a reversible opacity change due to the lower critical solution temperature (LCST) phenomenon. Of particular interest to the teachings of this invention are aqueous-based solutions of polymers that exhibit LCST behavior in the range of between about 30° C. to about 55° C. These include aqueous solution of poly(methylvinylether) (PVME), hydroxypropyl cellulose (HPC), and various polyacrylamides and derivatives which exhibit clouding in this temperature range. While there is a body of scientific literature that examines the LCST behavior of these materials in a relatively dilute solution (e.g., less than about 5 wt %), the development of useful thin films of these materials for application to a substrate, that also require reversible translucency, requires mechanically robust forms of these solutions.

While it is known in the art to provide various LCST compositions of polymer blends, aqueous solution and even crosslinked blends, what is lacking in the prior art is a teaching of an aqueous solution of polymers that can be subsequently crosslinked into mechanically robust gels that exhibit reversible LCST behavior. This invention addresses and fulfills this long felt need.

### SUMMARY OF THE PREFERRED EMBODIMENTS

The foregoing and other problems are overcome, and other advantages are realized, in accordance with the presently preferred embodiments of these teachings.

Disclosed herein is an aqueous solution of polymers that can be crosslinked into mechanically robust gels that exhibit reversible LCST behavior. Gels are defined herein as semisolid systems in which the movement of the dispersing medium is restricted by an interlacing network of particles or solvated macromolecules of the dispersed phase. The gels formed by crosslinking the formulations disclosed herein are of a type in which the macromolecules are uniformly distributed throughout a liquid with no apparent boundaries between the dispersed macromolecules and the liquid. Upon heating through the LCST transition point of the solution (gel), the gel changes to a two phase system in which the gel mass contains a suspension of small distinct particles capable of effectively scattering light. The result is a mechanically robust film capable of mimicking the LCST behavior of the solution from which it is derived.

The use of a curable crosslinking agent beneficially allows the LCST materials to be processed as solutions. Since the LCST material is in a solution, the incorporation of additional components, including surfactants, which modify the LCST transition point is also facilitated. The blending of other formulation components, such as but not limited to, optical brighteners, dyes, and surfactants is greatly facilitated by the low viscosity nature of the solution.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a cross-sectional view of a laminate structure containing an aqueous based gel exhibiting LCST behavior.

FIG. 2 is a cross-sectional view of a label capable of accepting a dataform.

FIG. 3 illustrates the transmission change in a 0.1 mm thick film of the gel which occurs on heating from about 30° C. to about 55° C.

FIG. 4A is a cross-sectional view of a sandwich used for fabrication of film subjected to crosslinking with UV radiation. FIG. 4B is a cross-sectional view of a fabrication of film subjected to UV crosslinking, wherein a single glass slide or plastic film is used to host the LCST formulation.

FIGS. 5A, 5B, and 5C illustrate a label applied to a substrate, and show the label before, during and after the label is heated at least to the LCST point so that indicia imprinted on the label can be read, relative to the background represented by the substrate, with high contrast and signal-to-noise ratio.

### DETAILED DESCRIPTION OF THE PREFERRED EMBODIMENTS

The invention may be described in the context of a general formula for the preparation of aqueous-based gels that exhibit LCST behavior. Gels are defined herein as semisolid systems in which the movement of the dispersing medium is restricted by an interlacing network of particles or solvated macromolecules of the dispersed phase. The gels formed by crosslinking the formulations disclosed herein are of a type in which the macromolecules are uniformly distributed throughout a liquid with no apparent boundaries between the dispersed macromolecules and the liquid. Upon heating through the LCST transition point of the solution (gel), the gel changes to a two phase system in which the gel mass contains a suspension of small distinct particles capable of effectively scattering light. The result is a mechanically robust film capable of mimicking the LCST behavior of the solution from which it is derived.

The formulation includes an aqueous solution of a polymer exhibiting LCST behavior, such as poly(methylvinyl ether), or PVME. The formulation then also includes a water dispersible crosslinking agent, such as poly(ethylene glycol) diacrylate and a crosslinking initiator such KIP100F™, of Sartomer Corporation. A number of other water dispersible crosslinking agents and initiators are commercially available. A surfactant is preferably then used to modify the LCST transition temperature, as well as the particle size and opacity of the materials after transition. The ratios and composition of the LCST polymer, water, crosslinking agent, initiator, and surfactant can all be adjusted to achieve the desired properties. These solutions and the subsequent gels can be optimized for various desired properties including, but not limited to, viscosity, mechanical strength, adhesion, opacity and the LCST transition point.

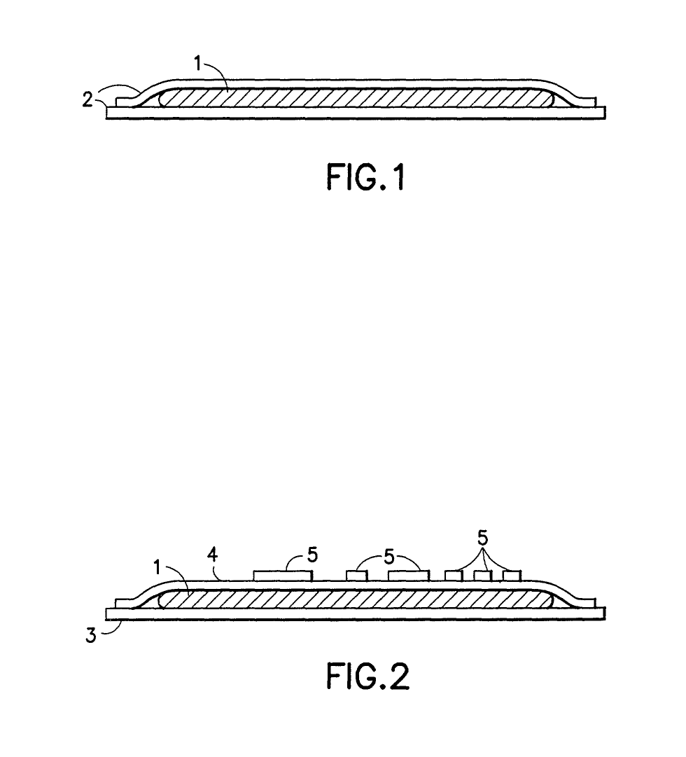

The prepared LCST solution may then be coated onto a variety of substrates, and often exhibit significant adhesive properties suitable for bonding two substrates. Therefore, a particular embodiment of this invention is related to the fabrication of thin laminate films in which the LCST solution 1 is sandwiched between two substrates 2 and subsequently cured to form a robust laminate structure, as shown in FIG. 1. The laminate structure then exhibits LCST behavior as the structure is heated through the gel LCST transition point. The substrates 2 can be chosen from a variety of transparent or opaque materials including glasses, thermoplastics, metals, and ceramics. FIG. 2 shows a presently preferred, but not limiting, embodiment where thin, transparent labels having a conventional clear, adhesive-backed film 3 on one side, an application of LCST solution 1, and a clear, printable film 4 on the opposite side are fabricated to form a LCST adhesive label capable of accepting print, such as alphanumeric characters, bar codes and other dataform symbologies 5.

The following materials, disclosed for practice of this invention, are considered illustrative of this invention, and are not limiting.

In a preferred embodiment, formulation of a gel exhibiting LCST behavior (herein LCST gel) in accordance with this invention comprises an aqueous solution of a material exhibiting LCST behavior, a water dispersible crosslinking agent, a crosslinking initiator and may include a surfactant.

The LCST material may be comprised of poly(methylvinyl ether) or hydroxypropylcellulose. The LCST material may be selected from the family of N-alkyl acrylamides.

The water dispersible crosslinking agent may be comprised of poly(ethylene glycol) diacrylate, or ethoxylated trimethylolpropane triacrylate, or ethoxylated bisphenol A diacrylate.

The crosslinking initiator may be comprised of a eutectic mixture of 2,4,6-trimethylbenzophenone and 4-methylbenzophenone (TZT™); a blend of phosphine oxide, alpha-hydroxy ketone and a benzophenone derivative (KTO46™); and a blend of phosphine oxide, alpha-hydroxy ketone and a benzophenone derivative (KIP100F™). The materials known as TZT™, KTO46™, or KIP100F™ are commercially available from Sartomer Corporation.

The surfactant may be comprised of sodium dodecyl sulfate, sodium dioctyl sulfosuccinate, or an amine salt of a branched or linear alkylbenzenesulfonic acid.

The LCST transition occurs between about 0° C. to about 100° C., preferably between about 20° C. to about 80° C., and most preferably between about 38° C. to about 55° C. The aqueous solution of a polymer exhibiting LCST behavior exhibits a change in optical transmission of visible light of at least 20% upon transition, preferably 50%, and most preferably 90% or greater. The viscosity of the aqueous solution of the polymer exhibiting LCST behavior before crosslinking is below 100,000 cP, preferably below 50,000 cP, and most preferably below 10,000 cP.

In another embodiment, a film formed from the LCST gel may exhibit adhesive properties making it suitable for application as a laminating adhesive. A laminated article can be comprised of the formulation given above and at least two supporting sheets, where the supporting sheets can be comprised of plastic, glass, metal, or ceramic, as shown in FIG. 1.

What follows are presently preferred, but not limiting, examples of formulations for a LCST gel. Included is an example of a process for fabrication of a laminated article therefrom. In various embodiments, the LCST may display other desirable properties in addition to reversible opacity, including but not limited to, adhesive properties.

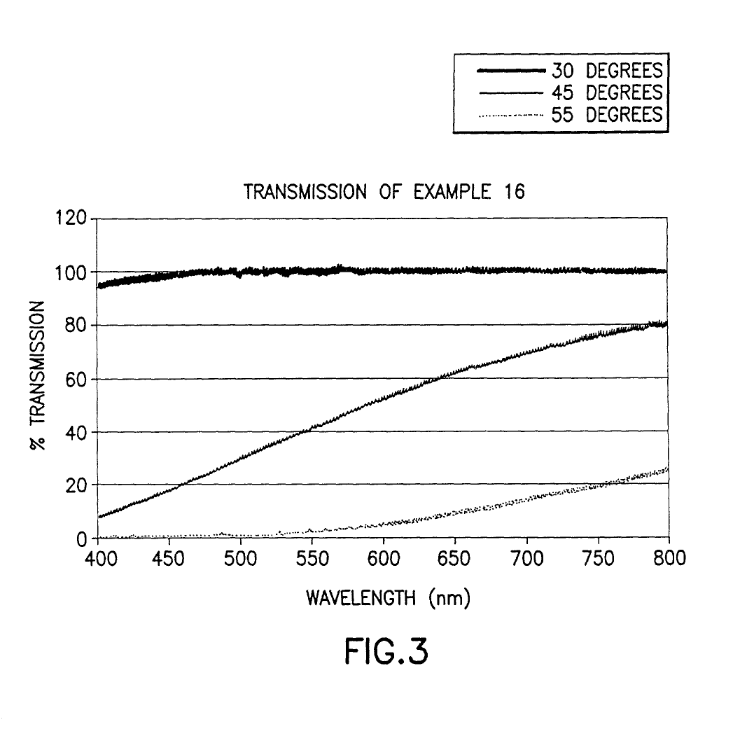

A plurality of preferred embodiments of aqueous solutions of polymers that can be crosslinked into mechanically robust gels that exhibit reversible LCST behavior is disclosed in Table 1, however, this list is not limiting of the invention. Table 1 provides a series of mixtures of poly(methylvinyl ether) ((60 wt % in water, PVME), water, sodium dodecyl sulfate (25 wt % in water, SDS), and a crosslinking mixture (PEG-575) of poly(ethylene glycol) diacrylate (molecular weight of approximately 575) and 5% KIP100F™ were prepared by manual stirring. The resulting solutions were all transparent in the visible range of 400-800 nm (>95% transmission versus water) at 30° C. or below. Transmission measurements in this range were recorded at 45° C. and 55° C. versus a water reference. Table 1 summarizes the composition and transmission data at 500 nm for each example. The transition temperature was recorded as the temperature at which the film became visibly white. FIG. 3 shows transmission curves for Example 16 of Table 1.

TABLE 1

| Example | Components, grams | | | | Gel Properties | | |
|---|---|---|---|---|---|---|---|
| # | 60% PVME | Water | 25% SDS | PEG-575 | Transition T (° C.) | % T, 45° C. | % T, 55° C. |
| 1 | 6.5 | 1.167 | 0.833 | 1.5 | 40 | 47.163 | 18.418 |
| 2 | 7.5 | 0.667 | 1 | 0.833 | 41 | 25.166 | 0.63148 |
| 3 | 6 | 1 | 2.5 | 0.5 | 46 | 57.3 | 29.048 |
| 4 | 6 | 3 | 0.5 | 0.5 | 39 | 5.1657 | 3.0294 |
| 5 | 6 | 0 | 2.5 | 1.5 | 46 | 80.211 | 37.285 |
| 6 | 7.5 | 1.5 | 0.5 | 0.5 | 38 | 1.1463 | 0.52417 |
| 7 | 6 | 2.25 | 1.25 | 0.5 | 41 | 15.631 | 1.3861 |
| 8 | 7.5 | 0 | 1 | 1.5 | 44 | 81.528 | 54.809 |
| 9 | 6 | 2 | 0.5 | 1.5 | 39 | 40.407 | 5.4845 |
| 10 | 7.5 | 0.5 | 0.5 | 1.5 | 44 | 53.926 | 1.6308 |
| 11 | 6 | 1.167 | 1.667 | 1.167 | 42 | 54.391 | 15.957 |
| 12 | 7.5 | 0 | 2 | 0.5 | 44 | 6.3153 | 0.85948 |
| 13 | 6.8 | 1.3 | 1.4 | 0.5 | 43 | 4.7153 | 0.55757 |
| 14 | 6.5 | 0 | 2.5 | 1 | 46 | 54.945 | 15.918 |
| 15 | 6.75 | 2.25 | 0.5 | 0.5 | 39 | 1.2005 | 1.5455 |
| 16 | 6.75 | 1.25 | 0.5 | 1.5 | 40 | 29.175 | 1.2005 |
| 17 | 6.764 | 1.931 | 0.583 | 0.722 | 39 | 2.6042 | 3.475 |
| 18 | 6.764 | 0.556 | 1.458 | 1.222 | 43 | 24.486 | 2.6029 |
| 19 | 6 | 2 | 0.833 | 1.167 | 41 | 14.057 | 1.0338 |
| 20 | 7.5 | 0 | 2 | 0.5 | 41 | 1.6818 | 0.44653 |

Other preferred embodiments of aqueous solutions of polymers that can be crosslinked into mechanically robust gels that exhibit reversible LCST behavior are disclosed in Table 2. Table 2, the use of different crosslinking materials is illustrated.

The crosslinking materials disclosed in Table 2 include triacrylates (such as SR9035™ SR259™ and SR415™, available from Sartomer Corporation), poly(ethyleneglycol) diacrylates (with molecular weights of 200 or 575 (referred to herein as PEG200 and PEG575, respectively)) and three crosslinking initiators (TZT™, KTO46™, and KIP100F™). These examples were prepared by mixing 8.0 grams of 50 wt % PVME in water, 1.0 g of 25 wt % sodium dodecyl sulfate in water, and 1.0 g of the crosslinking materials identified in Table 2. The results are summarized in Table 2.

TABLE 2

| | | Transition | % T, 500 nm | |
|---|---|---|---|---|
| Example # | Crosslinker | Temperature, C. | 45 C. | 55 C. |
| 21 | 5% TZT in SR9035 | 41 | 1.11 | 0.85 |
| 22 | 5% TZT in PEG575 | 41 | 0.76 | 0.63 |
| 23 | 5% TZT in PEG200 | 42 | 0.61 | 0.68 |
| 24 | 5% KTO46 in SR9035 | 40 | 0.49 | 0.46 |
| 25 | 5% KTO46 in PEG575 | 41 | 1.47 | 0.55 |
| 26 | 5% KTO/46 in PEG200 | 40 | 0.71 | 0.56 |
| 27 | 5% KIP100F in SR9035 | 41 | 0.76 | 0.54 |
| 28 | 5% KIP100F in SR415 | 42 | 7.08 | 0.74 |
| 29 | 5% KIP100F in SR259 | 40 | 0.46 | 0.47 |
| 30 | 5% KIP100F in PEG575 | 42 | 1.95 | 0.47 |
| 31 | 10% KIP100F in SR9035 | 42 | 0.57 | 0.49 |
| 32 | 10% KIP100F in PEG575 | 41 | 0.84 | 0.42 |
| 33 | 10% KIP100F in PEG200 | 40 | 0.52 | 0.58 |

In a further embodiment, an 80 g of a solution of PVME (50 wt % in water) is combined with 10 grams of an amine alkylbenzene sulfonate (distributed as NINATE™ 411 by Stepan Corporation), 9.5 g of poly(ethylene glycol) diacrylate (with a molecular weight of approximately 575), and 0.50 grams of KIP100F™ to yield a viscous clear solution that exhibits a LCST transition at approximately 38° C. For the sake of further reference, this material is referred to herein as “material 34.”

This invention further discloses a process for formation of a laminate. This example is intended to be illustrative of a process for formation of a laminate and not limiting of the invention.

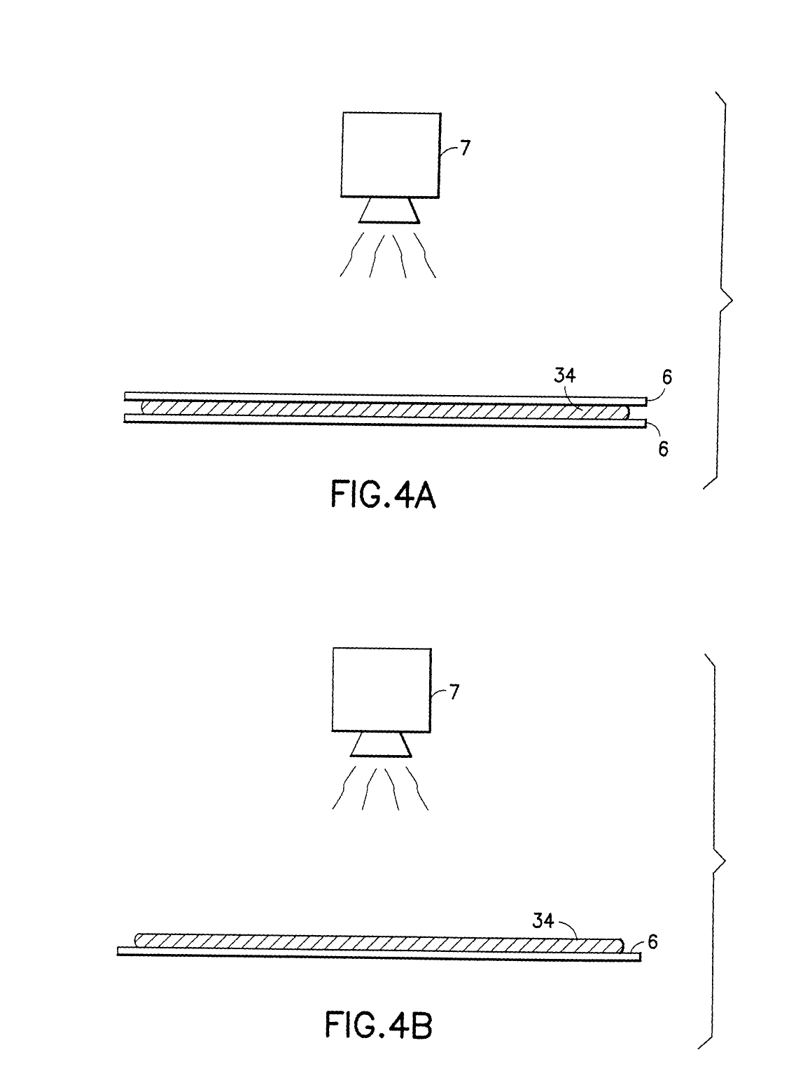

As shown in FIG. 4A, in this embodiment the material 34 can then be sandwiched between plastic films 6 and crosslinked by exposure to UV irradiation from a UV source 7 (250-370 nm) to yield a gel 1 that exhibits a LCST transition at approximately 38° C.

In another embodiment, as shown in FIG. 4B, material 34 can be deposited upon a single plastic film 6, and crosslinked by exposure to UV irradiation from a UV source 7 (250-370 nm) to yield a gel 1 that exhibits a LCST transition at approximately 38° C.

If desired, the crosslinked gel 1 can be removed from the plastic film(s) 6 for subsequent use as a film 1. In this embodiment, the film 1 comprised of material 34, once removed from the sandwich, is rubbery in appearance or feel.

The use of the technique described for manufacture of a film from material 34 is not limiting in that variations of LCST materials, curing stimulus, and sandwich support materials are within the teachings of this invention. A further variation is now provided.

In a further embodiment of this invention, a sample of material 34 was used to adhere two sheets of about two mil (0.05 mm) polyester together by roll lamination using an approximately 0.2 mm spacer between the polyester sheets. The resulting article was approximately 0.3 mm in thickness. This laminate was then exposed to UV irradiation to effect crosslinking. The sheets were well adhered and the LCST layer no longer flowed upon application of pressure to the laminate. The laminate structure exhibited reversible opacity change at the LCST transition of the gel (approximately 38° C. in this case). The laminate structure exhibited a change in transmission of visible light from 90% transmissive to <5% transmissive upon LCST induced opacity change.

If desired, a transparent adhesive could be applied to one of the surfaces of the laminate and the laminate sheet cut into smaller sized adhesive labels for application to substrates. In the presently preferred embodiment of this invention, the substrates are mail pieces, such as letters, business flats and packages, and the resulting labels are subsequently overprinted with mail delivery information, such as by printing with a bar code or alphanumeric characters.

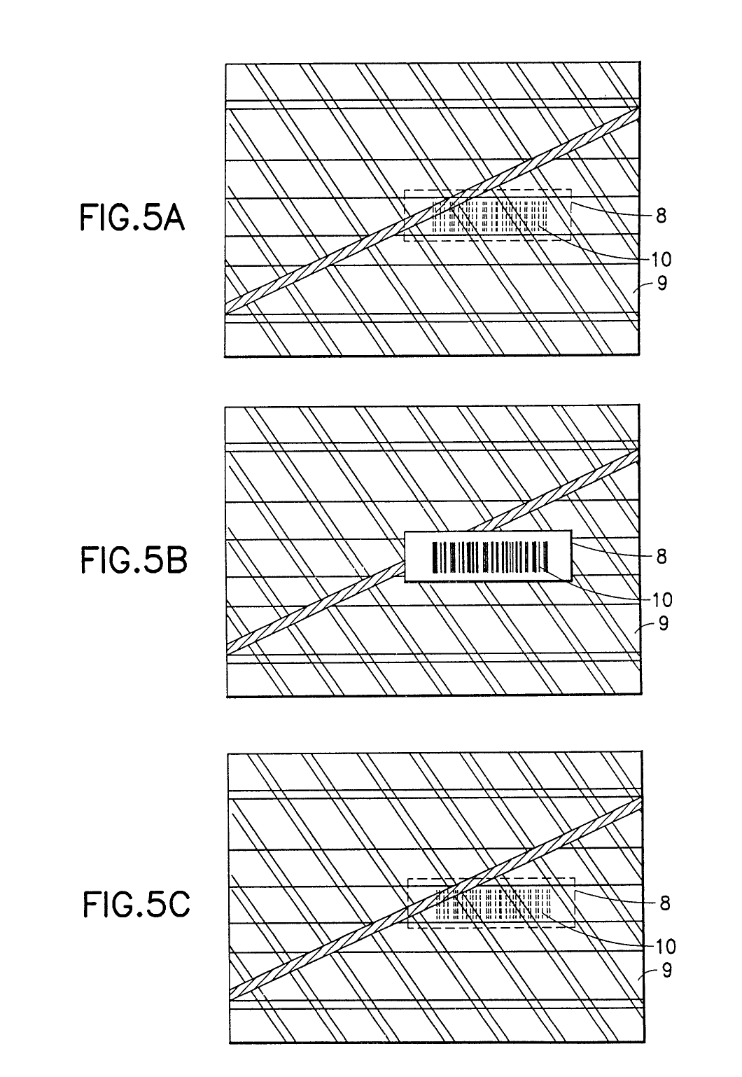

Referring to FIG. 5A, an advantage to this technique is that the label 8 bearing indicia 10 is normally transparent so that when applied over a patterned and/or colored and/or imprinted background of a substrate 9, the label 8 remains substantially invisible and unobtrusive. During a time when it is desired to read and decode the imprinted information the label 8 is heated at least to the LCST point. As shown in FIG. 5B, this results in the gel layer of the label 8 becoming substantially opaque and thus providing excellent optical contrast for automated equipment that is to read out and decode the imprinted information found in the indicia 10. After cooling back below the LCST the label 8 reverts to its initial substantially transparent condition, as shown in FIG. 5C.

Incorporated by reference herein is commonly assigned U.S. patent application Ser. No. 10/060,767, filed Jan. 30, 2002, entitled “Contrast Enhancing Marking System for Application of Unobtrusive Identification and Other Markings”, Nabil M. Lawandy, Timothy J. Driscoll, Charles M. Zepp.

The blending of other formulation components, such as but not limited to optical brighteners, dyes, surfactants, and other components is greatly facilitated by the low viscosity nature of the solution.

While described in the context of various specific chemical compounds and formulations, product names, weights, temperatures, wavelengths, and curing stimulus, these are intended to be viewed in as examples of the teachings of this invention, and not as limitations upon the practice of this invention.

What is claimed is:

1. A Lower Critical Solution Temperature LCST formulation comprising:
an aqueous solution of a material exhibiting LCST behavior;
a water dispersable crosslinking agent; and,
a crosslinking initiator.

2. A formulation according to claim 1 wherein crosslinking is initiated by stimulus comprised of ultraviolet radiation.

3. A formulation according to claim 1 wherein said material exhibiting LCST behavior is comprised of poly(methylvinyl ether).

4. A formulation according to claim 1 wherein said material exhibiting LCST behavior is comprised of hydroxypropylcellulose.

5. A formulation according to claim 1 wherein said material exhibiting LCST behavior is selected from the family of N-alkyl acrylamides.

6. A formulation according to claim 1 wherein said water dispersible crosslinking agent is comprised of poly(ethylene glycol) diacrylate.

7. A formulation according to claim 1 wherein said water dispersible crosslinking agent is comprised of ethoxylated trimethylolpropane triacrylate.

8. A formulation according to claim 1 wherein said water dispersible crosslinking agent is comprised of ethoxylated bisphenol A diacrylate.

9. A formulation according to claim 1 wherein said crosslinking initiator is comprised of a eutectic mixture of 2,4,6-trimethylbenzophenone and 4-methylbenzophenone.

10. A formulation according to claim 1 wherein said crosslinking initiator is comprised of a blend of phosphine oxide, alpha-hydroxy ketone and a benzophenone derivative.

11. A formulation according to claim 1 wherein said crosslinking initiator is comprised of a blend of phosphine oxide, alpha-hydroxy ketone and a benzophenone derivative.

12. A formulation according to claim 1 further comprising a surfactant.

13. A formulation according to claim 12 wherein said surfactant is comprised of sodium dodecylsulfate.

14. A formulation according to claim 12 wherein said surfactant is comprised of sodium dioctyl sulfosuccinate.

15. A formulation according to claim 12 wherein said surfactant is comprised of an amine salt of a branched or linear alkylbenzenesulfonic acid.

16. A formulation according to claim 1 in which the LCST transition occurs between about 0° C. to about 100° C.

17. A formulation according to claim 1 in which the LCST transition occurs between about 20° C. to about 80° C.

18. A formulation according to claim 1 in which the LCST transition occurs between about 38° C. to about 55° C.

19. A formulation according to claim 1 wherein said LCST formulation exhibits a change in optical transmission of visible light of at least 20% upon transition.

20. A formulation according to claim 1 wherein said LCST formulation exhibits a change in optical transmission of visible light of at least 50% upon transition.

21. A formulation according to claim 1 wherein said LCST formulation exhibits a change in optical transmission of visible light of at least 90% upon transition.

22. A formulation according to claim 1 where the viscosity of the aqueous solution of the polymer exhibiting LCST behavior before crosslinking is below about 100,000 cP.

23. A formulation according to claim 1 where the viscosity of the aqueous solution of the polymer exhibiting LCST behavior before crosslinking is below about 50,000 cP.

24. A formulation according to claim 1 where the viscosity of the aqueous solution of the polymer exhibiting LCST behavior before crosslinking is below about 10,000 cP.

25. A formulation according to claim 1 as a film.

26. A formulation according to claim 1 as a film with adhesive proper ties.

27. A multi-layered structure comprised of a LCST formulation comprising:
an aqueous solution of a material exhibiting LCST behavior
a water dispersable crosslinking agent, and,
a crosslinking initiator;
said LCST formulation being disposed adjacent to at least one supporting layer.

28. A multi-layered structure according to claim 27 wherein said supporting layer is comprised of plastic.

29. A multi-layered structure according to claim 27 wherein said supporting layer is comprised of glass.

30. A multi-layered structure according to claim 27 wherein said supporting layer is comprised of metal.

31. A multi-layered structure according to claim 27 wherein said supporting layer is comprised of ceramic.

32. A multi-layered structure according to claim 27 wherein said multi-layered structure has information recorded thereon.

33. A method for forming a gel comprising:
preparing a starting solution comprised of an aqueous solution of a material exhibiting LCST behavior, a water dispersable crosslinking agent, a crosslinking initiator; and, curing said starting solution to form a gel having Lower Critical Solution Temperature properties.

34. A method according to claim 33, wherein said starting solution further comprises a surfactant.

35. A method according to claim 33, wherein said step of curing comprises exposing said starting solution to UV radiation.

36. A structure comprised of a LCST formulation comprising:
an aqueous solution of a material exhibiting LCST behavior,
a water dispersable crosslinking agent, and,
a crosslinking initiator;
wherein
said structure has information recorded thereon,
said structure is disposed upon an object, and,
said information is read for sorting purposes.

37. A structure according to claim 36, wherein said object comprises a mail piece.

38. A mail piece with a structure applied to said mail piece wherein:
said structure has information recorded thereon; and,
said information is read for sorting purposes;
said structure being comprised of:
an aqueous solution of a material exhibiting LCST behavior;
a water dispersable crosslinking agent; and,
a crosslinking initiator.
